(19) United States
(12) Patent Application Publication
(10) Pub. No.: US 2006/0164013 A1
(43) Pub. Date: Jul. 27, 2006

(54) Plasma display panel and manufacturing method thereof

(75) Inventor: Min Soo Park, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/334,425

(22) Filed: Jan. 19, 2006

(30) Foreign Application Priority Data
Jan. 21, 2005 (KR) 10-2005-0005984

(51) Int. Cl. H01J 17/49; H01J 9/24

(52) U.S. Cl. 313/587; 313/582; 313/586; 445/24

(57) ABSTRACT

A plasma display panel and a method of manufacturing the same are provided. The plasma display panel includes a front glass panel in which a magnesium oxide (MgO) protective layer containing an element of the halogen group is formed on an upper part of a dielectric layer, and a rear glass panel which is separated from the front glass panel at a given distance and coalesced with the front glass panel.

This Nonprovisional application claims priority under 35 U.S.C. § 119(a) on Patent Application No. 10-2005-0005984 filed in Korea on Jan. 21, 2005 the entire contents of which are hereby incorporated by reference.

### BACKGROUND OF THE INVENTION

1. Field of the Invention

This document relates to a plasma display panel and a method of manufacturing the same.

2. Description of the Background Art

A conventional plasma display panel (PDP) is typically classified into an alternating current (AC) PDP and a direct current (DC) PDP depending on the type of discharge.

The DC PDP has a structure in which an electrode is exposed to a discharge space and the AC PDP has a structure in which an insulating layer is inserted between an electrode and a discharge space. Since the DC PDP has a structure where an electrode is exposed to plasma generated by a discharge, the DC PDP has a drawback in that a discharge current cannot be limited. Further, there is a problem in that ions having a large mass which are accelerated by an electric field, collide against the electrode to eject an electrode material, that is, to perform sputtering of an electrode material, which causes a reduction in life span of the DC PDP.

Most of the conventional PDPs that are developed or manufactured currently have adopted the structure of the AC PDPs where most of electrodes are protected by an insulator to overcome the problems associated with the DC PDP.

In a conventional AC PDP, a barrier rib formed between a front glass panel and a rear glass panel forms one unit cell and the cell is filled with a main discharge gas such as neon (Ne), helium (He) or an Ne-He gas mixture and an inert gas containing a small amount of xenon (Xe).

The AC PDP includes not only an insulating layer formed for protecting the electrode but also a protective layer which is formed on an upper part of the insulating layer to facilitate a discharge condition. Magensium oxide (MgO) which has a characteristic of sputtering-resistance for preventing the insulating layer from being damaged by ions and a high secondary electron emission coefficient for reducing a firing voltage been used as a material for the protective layer.

If MgO, which easily reacts with H₂O and CO₂, is exposed to the air during manufacturing the AC PDP, H₂O and CO₂ are absorbed on the MgO protective layer, thereby degrading a discharge characteristic.

Accordingly, after forming the MgO protective layer on the upper part of the insulating layer, a front glass panel and a rear glass panel of the AC PDP must be coalesced as soon as possible. However, there is a problem in that partial absorption of H₂O and CO₂ into the protective layer during coalescing cannot be prevented.

### SUMMARY OF THE INVENTION

Accordingly, an object of the present invention is to solve at least the problems and disadvantages of the background art.

An embodiment of the present invention provides a plasma display panel, which can improve a discharge characteristic by improving the surface processing of a protective layer of a front glass panel, and a method of manufacturing the same.

According to an aspect of the present invention, there is provided a plasma display panel comprising a front glass panel in which a MgO protective layer containing an element of the halogen group is formed on an upper part of a dielectric layer, and a rear glass panel which is separated from the front glass panel at a given distance and coalesced with the front glass panel.

According to another aspect of the present invention, there is provided a method of manufacturing a plasma display panel comprising depositing MgO on an upper part of a dielectric layer of a front glass panel within a vacuum chamber to form a protective layer, injecting a predetermined gas existing in an ion state in a plasma state within the vacuum chamber, and inducing plasma discharge within the vacuum chamber to process the surface of the protective layer.

The embodiment of the present invention reduces an amount of time required in an aging process in the method of manufacturing the plasma display panel.

Further, the embodiment of the present invention improves a discharge characteristic by improving a secondary electron emission coefficient of the protective layer.

### BRIEF DESCRIPTION OF THE DRAWINGS

The accompany drawings, which are included to provide a further understanding of the invention and are incorporated in and constitute a part of this specification, illustrate embodiments of the invention and together with the description serve to explain the principles of the invention. In the drawings:

FIG. 1 shows a structure of a plasma display panel (PDP) according to an embodiment of the present invention;

FIG. 2 is a block diagram for sequentially illustrating a method of manufacturing a PDP according to the embodiment of the present invention;

FIG. 3 illustrates in detail a method of the surface processing of a protective layer of a PDP according to the embodiment of the present invention; and

FIGS. 4a and 4b illustrate a method of evaporating a protective layer of a PDP according to the embodiment of the present invention using an E-beam method.

### DETAILED DESCRIPTION OF PREFERRED EMBODIMENTS

Reference will now be made in detail to embodiments of the present invention, examples of which are illustrated in the accompanying drawings.

A plasma display panel (PDP) according to an embodiment of the present invention comprises a front glass panel in which a magnesium oxide (MgO) protective layer containing an element of the halogen group is formed on an upper part of a dielectric layer, and a rear glass panel which is separated from the front glass panel at a given distance and coalesced with the front glass panel.

The element of the halogen group is formed on the surface of the MgO protective layer.

The element of the halogen group comprises fluorine (F).

A method of manufacturing a plasma display panel according to the embodiment of the present invention comprises depositing MgO on an upper part of a dielectric layer of a front glass panel within a vacuum chamber to form a protective layer, injecting a predetermined gas ionized in a plasma state into the vacuum chamber, and inducing a plasma discharge within the vacuum chamber to perform a surface processing of the protective layer.

The predetermined gas comprises a gas containing an element of the halogen group.

The predetermined gas comprises fluorine (F).

The gas containing the element of the halogen group comprises at least one of F₂, NF₃, CF₄ or SF₆.

The protective layer is formed using any one among an E-beam method, a sputtering method or a sol-gel method.

Hereinafter, exemplary embodiments of the present invention will be described in detail with reference to the attached drawings.

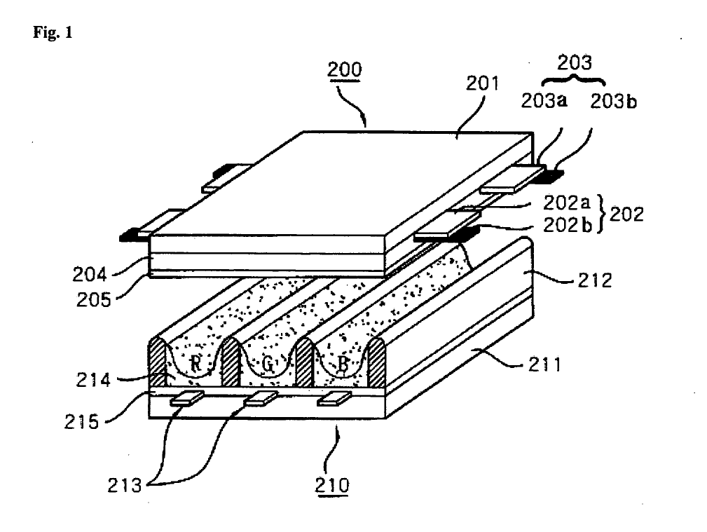

FIG. 1 shows a structure of a PDP according to an embodiment of the present invention.

As shown in FIG. 1, the PDP includes a front glass panel 200 and a rear glass panel 210 which are disposed in parallel to face each other at a given distance. A plurality of sustain electrode pairs in which a plurality of scan electrodes 202 and a plurality of sustain electrodes 203 are formed in pairs are arranged on a front glass 201 of the front glass panel 200 that is a display surface for displaying images. A plurality of address electrodes 213 are arranged on a rear glass 211 of the rear glass panel 210 to intersect the plurality of sustain electrode pairs.

The front glass panel 200 includes the scan electrode 202 and the sustain electrode 203, which are discharged by each other in one discharge cell and maintain light-emission of the cell. The scan electrode 202 and the sustain electrode 203 each include transparent electrodes 202a and 203a made of a transparent material and bus electrodes 202b and 203b made of a metal material such as Ag, making in pairs to form a sustain electrode pair. The scan electrode 202 and the sustain electrode 203 restrict a discharge current and are covered with a dielectric layer 204 that provides insulation between the sustain electrode pairs. A protective layer 205 is formed on an upper surface of the dielectric layer 204 to facilitate discharge conditions. The protective layer 205 is mainly made of MgO and an element of the halogen group.

The protective layer can include two layers. That is, a MgO layer is formed on the upper surface of the dielectric layer 204 and a layer containing the element of the halogen group is formed on an upper surface of the MgO layer. The element of the halogen group prevents H₂O and CO₂ from being absorbed on MgO.

Fluorine (F) is preferable among the several elements of the halogen group.

Stripe type barrier ribs 212 are arranged in parallel in the rear glass panel 210 to form a plurality of discharge spaces, that is, a plurality of discharge cells. The plurality of address electrodes 213 which perform address discharge to generate vacuum ultraviolet light are disposed in parallel to the barrier bibs 212. Red (R), green (G) and blue (B) phosphors 214 which radiate visible light for the image display during the addresss discharge are coated on an upper surface of the rear glass panel 210. A lower dielectric layer 215 for protecting the address electrodes 213 is formed between the address electrodes 213 and the phosphors 214.

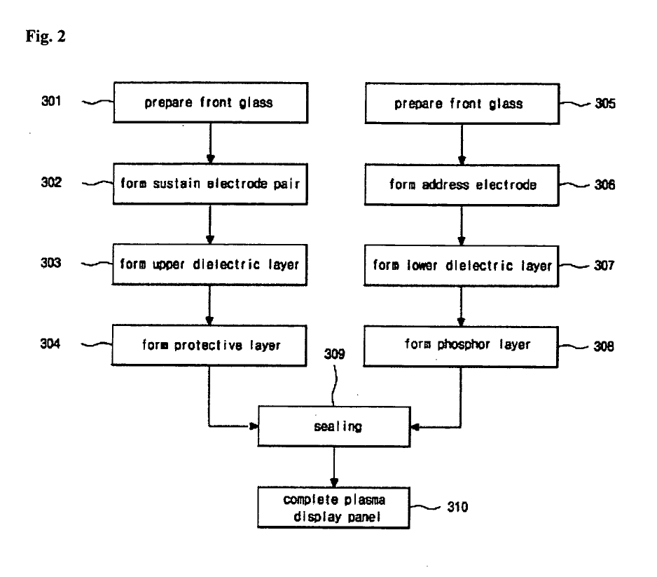

FIG. 2 is a block diagram sequentially illustrating a method of manufacturing a PDP according to the embodiment of the present invention.

As shown in FIG. 2, a method of manufacturing the PDP according to the embodiment of the present invention includes processes of manufacturing the front glass panel shown in the left side of FIG. 2, processes of manufacturing the rear glass panel shown in the right side of FIG. 2, and a sealing process shown in the lower side of FIG. 2.

First, the processes of manufacturing the front glass panel shown in the left side of FIG. 2 are described. Front glass used as a base of the front glass panel is prepared in step 301, and then the plurality of sustain electrode pairs are formed on an upper part of the front glass in step 302. Afterwards, an upper dielectric layer is formed on upper parts of the sustain electrode pairs in step 303 and the protective layer made of MgO for protecting the sustain electrode pairs is formed on an upper part of the upper dielectric layer in step 304. At this time, the surface of the protective layer is processed by a gas containing an element of the halogen group.

Next, the processes of manufacturing the rear glass panel shown in the right side of FIG. 2 are described. As with the front glass panel, first, rear glass used as a base of the rear glass panel is prepared in step 305, and then the plurality of address electrodes are formed on the rear glass to intersect and face the sustain electrode pairs formed on the front glass panel in step 306. Afterwards, a lower dielectric layer is formed on upper surfaces of the address electrodes in step 307 and a phosphor layer is formed on an upper surface of the lower dielectric layer in step 308.

The front glass panel and the rear glass panel thus manufactured are sealed to each other in step 309 to complete the PDP in step 310.

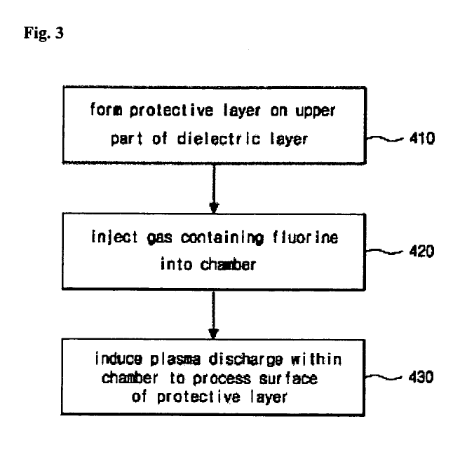

FIG. 3 illustrates in detail a method of the surface processing of a protective layer of a PDP according to the embodiment of the present invention.

As shown in FIG. 3, the protective layer of the PDP according to the embodiment of the present invention is first formed by depositing MgO on the upper part of the dielectric layer of the front glass panel in step 410.

Subsequently, a predetermined gas ionized in a plasma state is injected into a vacuum chamber in step 420. It is preferable that the predetermined gas uses the gas containing an element of the halogen group. More preferably, the predetermined gas includes a fluorine (F).

The fluorine (F)-containing gas is at least one of F₂, NF₃, CF₄ or SF₆.

Next, a plasma discharge is induced within the chamber to process the surface of the protective layer in step 430. The surface processing of the protective layer is carried out using a sputtering method which physically etches the surface of the protective layer.

The protective layer formed on the upper part of the dielectric layer can be deposited using an E-beam method, a sputtering method or a sol-gel method, etc. Hereinafter, an evaporating process of the protective layer using the E-beam method aming the methods will be described.

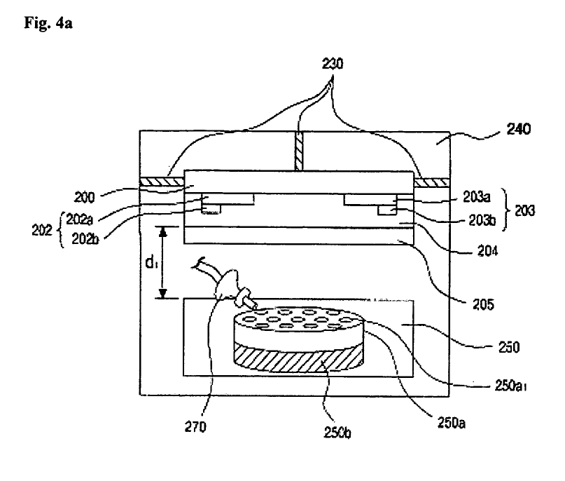

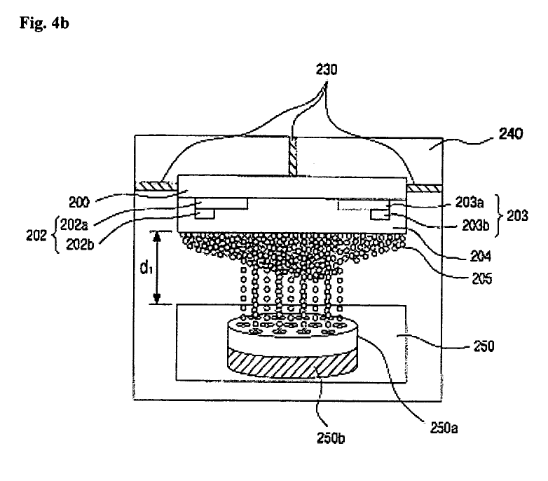

FIGS. 4a and 4b illustrate a method of evaporating a protective layer of a PDP according to the embodiment of the present invention using an E-beam method.

As shown in FIG. 4a, the front glass panel 200 in which the dielectric layer 204 is formed on the upper parts of the sustain electrode pairs is located inside a vacuum chamber 240 for depositing the protective layer 205. The protective layer 205 is evaporated on the upper part of the dielectric layer 204 using a protective layer evaporating apparatus. The protective layer evaporating apparatus includes a panel fixing part 230 for fixing the front glass panel 200 and a vapor evaporating part 250 which is separated from the front glass panel 200 at a predetermined distance and evaporates the protective layer 205 typically made of MgO on the front glass panel 200. The vapor evaporating part 250 fills a MgO material 250b in a hearth 250a, concentratedly injecting the MgO material 250b through orifices 250a1 formed in the hearth 250a using an electron-beam gun 270.

The front glass panel 200 located on the panel fixing part 230 inside the vacuum chamber 240 is separated from the vapor evaporating part 250 by a distance d₁ of 10 cm. As shown in FIG. 4b, the MgO material 250b of the vapor evaporating part 250 is concentratedly injected through the orifices 250a1 formed in the hearth 250a using an electron-beam gun 270. Accordingly, most of the energy of the MgO material 250b is converted into heat so that vapor which is a sublimate state of gas is adhered to the surface of the dielectric layer 204 of the front glass panel 200.

As described above, in the PDP according to the embodiment of the present invention, after the injection of a fluorine (F)-containing gas, a plasma discharge is generated. Thus, although the surface of the MgO protective layer is exposed to the air after the evaporation of MgO so that impurities such as H₂O, CO2 are absorbed thereon, the impurities absorbed on the surface of the MgO protective layer can be removed.

Since ionized fluorine (F) gas removes defect site of a MgO layer, although the protective layer is exposed to the air after the surface processing of the protective layer, the protective layer is ptotected from being contaminated again.

Accordingly, since the surface of the MgO protective layer is clean, a secondary electron emission coefficient improves so that a discharge characteristic improves and an amount of time required in an aging process for obtaining a stable discharge state decreases signficantly.

The invention being thus described may be varied in many ways. Such variations are not to be regarded as a departure from the spirit and scope of the invention, and all such modifications as would be obvious to one skilled in the art are intended to be included within the scope of the following claims.

What is claimed is:

1. A method of manufacturing a plasma display panel (PDP) comprising:
depositing magnesium oxide (MgO) on an upper part of a dielectric layer of a front glass panel within a vacuum chamber to form a protective layer;
injecting a predetermined gas ionized in a plasma state into the vacuum chamber; and
inducing a plasma discharge within the vacuum chamber to perform a surface processing of the protective layer.

2. The method of claim 1, wherein the predetermined gas comprises a gas containing an element of the halogen group.

3. The method of claim 2, wherein the predetermined gas comprises fluorine (F).

4. The method of claim 2, wherein the gas containing the element of the halogen group comprises at least one of F₂, NF₃, CF₄ or SF₆.

5. The method of claim 1, wherein the protective layer is formed using any one of an E-beam method, a sputtering method or a sol-gel method.

6. A plasma display panel (PDP) comprising:
a front glass panel in which a MgO protective layer containing an element of the halogen group is formed on an upper part of a dielectric layer; and
a rear glass panel which is separated from the front glass panel at a given distance and coalesced with the front glass panel.

7. The PDP of claim 6, wherein the element of the halogen group is formed on the surface of the MgO protective layer.

8. The PDP of claim 6, wherein the element of the halogen group comprises fluorine (F).
